(19) United States
(12) Patent Application Publication
(10) Pub. No.: US 2026/0330310 A1
(43) Pub. Date: Oct. 22, 2026

(54) INDUSTRIAL FOUNDATION MODEL PLATFORM AND SYSTEM THEREOF

(71) Applicant: BEIHANG UNIVERSITY, Beijing (CN)

(72) Inventors: Lei REN, Beijing (CN); Haiteng WANG, Beijing (CN); Haoze LI, Beijing (CN); Yuqing WANG, Beijing (CN); Shixiang LI, Beijing (CN); Zidi JIA, Beijing (CN); Jiabao DONG, Beijing (CN)

(73) Assignee: BEIHANG UNIVERSITY, Beijing (CN)

(21) Appl. No.: 19/529,385

(22) Filed: Feb. 4, 2026

(30) Foreign Application Priority Data
Sep. 26, 2024 (CN) 202411354282.5

(51) Int. Cl. G06N 20/00

(52) U.S. Cl. CPC G06N 20/00

(57) ABSTRACT

The present application provides an industrial foundation model platform and a system thereof. The industrial foundation model platform is configured to train an industrial foundation model. The industrial foundation model platform includes an infrastructure layer, a base layer, a model adaptation layer, an interaction layer, and an application layer. The infrastructure layer is configured to construct basic resources for training the industrial foundation model. The base layer is configured to perform industrial multimodal pre-training to improve processing capability of the industrial foundation model for multimodal data. The model adaptation layer is configured to perform industrial mechanism embedded fine-tuning to improve processing capability of the industrial foundation model for a specific task and generalization capability in an unknown domain scenario. The interaction layer is configured to improve interaction capability of the industrial foundation model.

### CROSS-REFERENCE TO RELATED APPLICATION

This application claims priority to Chinese Patent Application No. 202411354282.5, filed on Sep. 26, 2024, which is hereby incorporated by reference in its entirety.

### TECHNICAL FIELD

The present application relates to the field of computer applications, in particular, to an industrial foundation model platform and a system thereof.

### BACKGROUND

With the arrival of an Internet of Things era, industrial foundation models are constructed by establishing complex mathematical models and computer simulations, to simulate, predict, and control the operation and behavior of industrial systems.

However, the existing industrial foundation models have problems such as poor generalization capability, low training efficiency, and lack of understanding of industrial mechanisms. Herein, the poor generalization capability means that the existing industrial foundation models can only be applied to a single industrial scenario and lack flexibility and adaptability. The low training efficiency means that the existing industrial foundation models require independent training, which is time-consuming and resource-intensive. The lack of understanding of industrial mechanisms means that the existing industrial foundation models lack an in-depth understanding of specific mechanisms in an industrial domain, resulting in inaccurate and unreliable output results of models.

Therefore, the problems of poor generalization capability, low training efficiency, and lack of understanding of industrial mechanisms of existing industrial foundation models are urgently solved in the present application.

### SUMMARY

The present application provides an industrial foundation model platform and a system thereof, to solve the problems of poor generalization capability, low training efficiency, and lack of understanding of industrial mechanisms of existing industrial foundation models.

A first aspect of the embodiments of the present application provides an industrial foundation model platform, where the industrial foundation model platform is configured to train an industrial foundation model, and the industrial foundation model platform includes: an infrastructure layer, a base layer, a model adaptation layer, an interaction layer, and an application layer;

where the infrastructure layer is configured to construct basic resources for training the industrial foundation model;

the base layer is configured to perform industrial multimodal pre-training on a preset industrial base model through a preset multimodal dataset to improve processing capability of the industrial foundation model for multimodal data, where the industrial base model is a foundation of the industrial foundation model, and the industrial base model possesses general problem-solving capability for industrial tasks;

the model adaptation layer is configured to perform industrial mechanism embedded fine-tuning on the pre-trained industrial base model through a preset specific dataset to obtain the industrial foundation model, where the specific dataset includes a task-oriented foundation model and a domain foundation model, where the task-oriented foundation model is configured to perform multi-task instruction fine-tuning on the pre-trained industrial base model to improve processing capability of the industrial foundation model for a specific task, where the domain foundation model is configured to perform domain-specific knowledge embedding and adapter fine-tuning on the multi-task instruction fine-tuned industrial base model to improve generalization capability of the industrial foundation model in an unknown domain scenario;

the interaction layer is configured to improve interaction capability of the industrial foundation model through industrial efficient inference, where the industrial foundation model is configured to respectively interact with technical personnel and a cyber-physical system;

the application layer is configured to manifest functions of the industrial foundation model.

In an embodiment, in the industrial foundation model platform mentioned above, the task-oriented foundation model includes: an intelligent question-and-answering model, a scene cognition model, a process decision-making model, a terminal control model, a content generation model and a scientific discovery model;

where the functions of the industrial foundation model include: intelligent question-and-answering, scene cognition, process decision-making, terminal control, content generation and scientific discovery.

In an embodiment, in the industrial foundation model platform mentioned above, the functions of the industrial foundation model are configured to support applications in research and development design, manufacturing, test and validation, management, and operation and maintenance service.

In an embodiment, in the industrial foundation model platform mentioned above, the model adaptation layer is further configured to perform scene-knowledge-internalization-enhanced self-training on the domain-specific knowledge embedded and adapter fine-tuned industrial base model through preset limited labeled data, to improve processing capability of the industrial foundation model in industrial subdivision scenarios.

In an embodiment, in the industrial foundation model platform mentioned above, the base layer is preset with respective toolchains for industrial multimodal pre-training, industrial mechanism embedded fine-tuning, and industrial efficient inference, and a plurality of industrial template foundation models, where the industrial base model is one of the plurality of industrial template foundation models.

In an embodiment, in the industrial foundation model platform mentioned above, the basic resources include: industrial data, computing resources and industrial knowledge;

where the industrial data is used for providing training data for the industrial foundation model;

the computing resources are used for providing computing power support for the industrial foundation model;

the industrial knowledge is used for providing deep-level logic for the industrial foundation model.

In an embodiment, in the industrial foundation model platform mentioned above, the industrial foundation model platform further includes: a pre-training module supported by the base layer;

where the pre-training module is configured to perform the industrial multimodal pre-training on the industrial base model through at least one of multiple pre-training methods, where the multiple pre-training methods include: a distributed training method, a transfer learning training method, a self-supervised learning method, and a multi-task training method;

where the pre-training module is further configured to set industrial data called by the industrial base model and a model parameter of the industrial base model.

In an embodiment, in the industrial foundation model platform mentioned above, the industrial foundation model platform further includes: an adaptation and fine-tuning module supported by the model adaptation layer;

where the adaptation and fine-tuning module is configured to perform the industrial mechanism embedded fine-tuning on the pre-trained industrial base model through one of multiple fine-tuning training methods, where the multiple fine-tuning training methods include: an industrial knowledge integration and industrial mechanism embedding method, a supervised fine-tuning method, a direct preference optimization method, and a reinforcement learning from human feedback method.

In an embodiment, in the industrial foundation model platform mentioned above, the industrial foundation model platform further includes: an interactive inference module supported by the interaction layer;

where the interactive inference module is configured to improve interaction capability of the industrial foundation model through a plurality of interactive inference optimization methods, where the plurality of interactive inference optimization methods include: inference acceleration, industrial knowledge base retrieval-augmented generation, model orchestration, and plugin mechanism.

In an embodiment, in the industrial foundation model platform mentioned above, the industrial foundation model platform further includes: an evaluation module supported by the application layer;

where the evaluation module is configured to evaluate functions of the industrial foundation model through at least one of multiple evaluation methods, where the multiple evaluation methods include: an automatic evaluation and a manual evaluation.

A second aspect of the embodiments of the present application provides an industrial foundation model platform, where the industrial foundation model platform system includes: an industrial foundation model, and a cyber-physical system which interacts with the industrial foundation model;

where the industrial foundation model is a model obtained through training by the industrial foundation model platform according to any one of the first aspect.

The industrial foundation model platform and the system thereof provided in the embodiment of the present application include an infrastructure layer, a base layer, a model adaptation layer, an interaction layer, and an application layer. The infrastructure layer is configured to construct basic resources for training the industrial foundation model. The base layer is configured to perform industrial multimodal pre-training to improve processing capability of the industrial foundation model for multimodal data. The model adaptation layer is configured to perform industrial mechanism embedded fine-tuning to improve processing capability of the industrial foundation model for a specific task and generalization capability in an unknown domain scenario. The interaction layer is configured to improve interaction capability of the industrial foundation model. The application layer is configured to manifest functions of the industrial foundation model. The following technical effects are achieved: the model adaptation layer improves the generalization capability of the industrial foundation model in an unknown domain scenario through the domain foundation model, solving the problem of poor generalization capability of existing industrial foundation models. The model adaptation layer improves the processing capability of the industrial foundation model for the specific task through the industrial base model, solving the problem of lack of understanding of the industrial mechanism of the existing industrial foundation models. The interaction layer improves the interaction capability of the industrial foundation model through the industrial efficient inference, solving the problem of low training efficiency of the existing industrial foundation models.

### BRIEF DESCRIPTION OF DRAWINGS

In order to more clearly illustrate technical solutions in embodiments of the present application or in the prior art, a brief introduction of drawings required to be used in the description of the embodiments or the prior art is provided below. It is obvious that the drawings described below are some embodiments of the present application. For ordinary person skilled in the art, other drawings can also be obtained according to these drawings without creative labor.

FIG. 1 is an application scenario diagram of an industrial foundation model platform provided by an embodiment of the present application.

FIG. 2 is a first structural schematic diagram of an industrial foundation model platform provided by an embodiment of the present application.

FIG. 3 is a second structural schematic diagram of an industrial foundation model platform provided by an embodiment of the present application.

### REFERENCE SIGNS

100-technical personnel;
200-industrial foundation model platform;
210-infrastructure layer;
220-base layer;
221-pre-training module;
230-model adaptation layer;
231-adaptation and fine-tuning module;
240-interaction layer;
241-interactive inference module;
250-application layer;
251-evaluation module;
310-cyber system;
320-physical system.

### DESCRIPTION OF EMBODIMENTS

Exemplary embodiments will be illustrated in detail here, examples of which are shown in the accompanying drawings. When the description below relates to drawings, the same numbers in different drawings represent the same or similar elements unless otherwise indicated. The implementations described in the following exemplary embodiments do not represent all implementations consistent with the present application. On the contrary, they are merely examples of apparatuses and methods that are consistent with some aspects of the present application as detailed in the appended claims.

The technical solution of the present application is described in detail below with specific embodiments. The following several specific embodiments may be combined with each other, and the same or similar concepts or processes will not be repeated in some embodiments. The embodiments of the present application are described below with reference to the drawings.

In the embodiments of the present application, the words “first”, “second”, etc. are used to distinguish the same or similar items with basically the same function and effect. It can be understood by a person skilled in the art that the words “first”, “second”, etc. neither limit the quantity nor execution order, and the words “first”, “second”, etc. do not necessarily mean that they are different. It should be noted that, in the embodiments of the present application, words such as “exemplary” or “for example” are used to indicate being an example, illustration or explanation. Any embodiment or design solution described herein as “exemplary” or “for example” in the present application should not be interpreted as being more preferred or advantageous than other embodiments or design solutions. To be precise, the use of words such as “exemplary” or “for example” is intended to present a relevant concept in a specific manner. In the embodiments of the present application, “at least one” refers to one or more, and “a plurality of” refers to two or more than two.

It should be noted that, in the embodiments of the present application, the phrase “when…” may be an instant a situation occurs or within a period of time after a situation has occurred, which is not specifically limited in the embodiments of the present application. In addition, the industrial foundation model platforms provided in the embodiments of the present applications are merely provided as examples, and the industrial foundation model platforms may contain more or fewer contents.

For the convenience of clearly illustrating technical solutions of the embodiments of the present application, some terms and technologies involved in the embodiments of the present application are briefly introduced below.

Internet of Things (IoT): refers to a network that, through information sensing devices such as devices based on Radio Frequency Identification (RFID), Global Navigation Satellite System (GNSS), infrared sensing or laser scanning, connects any item to the Internet according to an agreed protocol to exchange information and communicate, so as to achieve intelligent identification, positioning, tracking, monitoring and management. Application fields of the IoT are extensive, including aerospace, shipbuilding, automotive, chemical engineering, metallurgical, iron and steel, and many other fields.

Generalization capability of an industrial model: refers to an applicability and accuracy of an industrial foundation model in an unknown domain scenario. An industrial foundation model with good generalization capability can not only accurately simulate, predict, and control industrial scenarios that have been seen in the training dataset, but also make a reasonable prediction and judgment on an unknown domain scenario. Such capability helps an industrial foundation model maintain high efficiency and reliability in complex and changeable industrial environments.

Industrial mechanism: refers to professional knowledge such as principles, theorems, and laws in industrial production processes. The industrial mechanisms include thermodynamic equations and chemical reaction kinetic equations, etc.

Understanding of industrial mechanisms by industrial models: refers to the understanding and grasping of the interaction and influence mechanisms among various components within an industrial system during a construction and an operation of an industrial foundation model. Through an in-depth understanding, the behavior of the industrial system can be simulated and predicted more accurately, the industrial mechanism of the model can be improved, and accuracy and reliability of the industrial foundation model can be achieved. At the same time, such understanding also helps discover problems and bottlenecks existing in the industrial system to provide a strong support for optimizing and improving the industrial system.

In order to clearly understand the technical solutions of the present application, the solutions in the prior art are introduced firstly in detail.

An industrial foundation model refers to a model which is constructed through complex mathematical models and computer simulation and can simulate, predict, and control the operation of an industrial system. The industrial foundation model usually involves knowledge of multiple disciplinary domains, and aims to achieve an accurate grasp of the overall performance and behavior of the industrial system through highly integrated and comprehensive analysis methods.

However, the existing industrial foundation models have problems such as poor generalization capability, low training efficiency, and lack of understanding of industrial mechanisms. Herein, the poor generalization capability means that the existing industrial foundation models can only be applied to a single industrial scenario and lack flexibility and adaptability. The low training efficiency means that the existing industrial foundation models require independent training, which is time-consuming and resource-intensive. The lack of understanding of industrial mechanisms means that the existing industrial foundation models lack an in-depth understanding of specific mechanisms in an industrial domain, resulting in inaccurate and unreliable output results of models.

In the research, it is found that for the problem of poor generalization capability, the generalization capability of the industrial foundation model can be improved through preset large models and diversified training methods, so that they can better adapt to different industrial application scenarios. For the problem of low training efficiency, fast training of the industrial foundation model can be achieved on the platform by using efficient model training means, so that training efficiency can be improved, and time and cost can be reduced. For the problem of lack of understanding of industrial mechanisms, the understanding of industrial mechanisms by industrial foundation model can be enhanced by introducing mechanism embedded fine-tuning methods based on an industrial knowledge base, so that the accuracy and effectiveness of the model in practical applications can be improved.

Based on the above creative discoveries, an industrial foundation model platform and a system thereof are provided in the present application. The industrial foundation model platform is a one-stop large model development and service operation platform, which covers multiple key links such as model training, model fine-tuning, model inference, and model evaluation. In the model training link, it not only provides a dataset management and a model fine-tuning function, but also presets multiple large models for users to choose to support diversified training modes to meet different requirements. In the model inference link, through multiple interactive inference optimization methods, the industrial foundation model platform improves inference speed and quality of model output. In the model evaluation link, the industrial foundation model platform provides two methods of an automatic evaluation and a manual evaluation to ensure a comprehensive and accurate understanding of model performance.

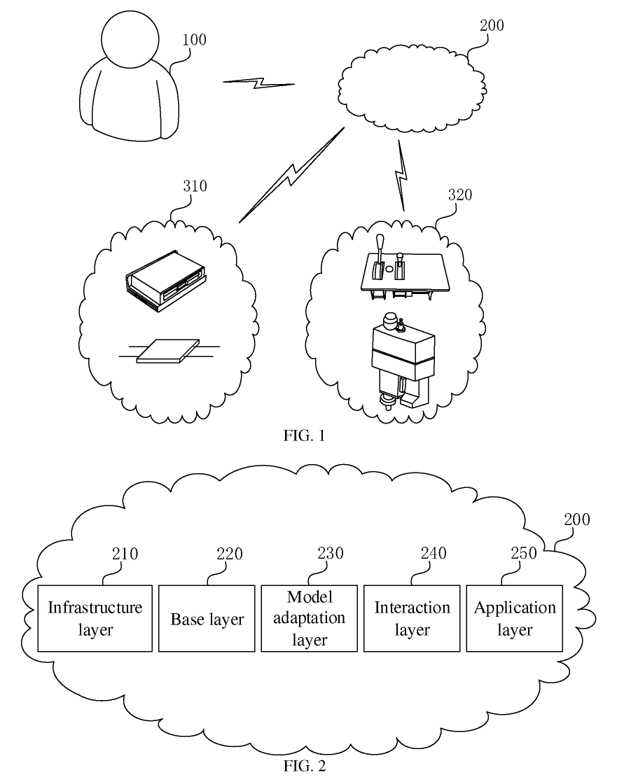

An application scenario of an industrial foundation model platform provided by embodiments of the present application is introduced below. FIG. 1 is an application scenario diagram of an industrial foundation model platform provided by embodiments of the present application. It should be noted that FIG. 1 only shows an example of a scenario where the embodiments of the present application can be applied, to help those skilled in the art understand the technical content of the present application, but it does not mean that the embodiments of the present application cannot be used for other devices, systems, environments, or scenarios.

As shown in FIG. 1, the application scenario includes three major interactive objects including technical personnel 100, an industrial foundation model platform 200 and a Cyber-Physical System (CPS), which form an organic whole and perform interactive assistance for industrial production processes.

The technical personnel 100 can be various types of specialized personnel, including research and development personnel, engineering personnel, production operators, and management personnel, etc. The technical personnel 100 are used to train an industrial foundation model through the industrial foundation model platform 200, according to different objectives and plans of specific industrial tasks, and to interact with the industrial foundation model.

The cyber-physical system is a complex system which includes computation, networks and physical entities. It achieves an interaction between a cyberspace and a physical world through an organic fusion and in-depth collaboration of 3C (Computing, Communication, Control) technologies. In the cyber-physical system, a cyber system 310 and a physical system 320 are two important components, which are objects of perception, action, and control of the industrial foundation model.

The cyber system 310 refers to technologies and systems related to computation, communication and control, covering a computer network, an information system, a control algorithm, and other aspects. It is a core part of the cyber-physical system responsible for data processing, information transmission and decision-making. The cyber system 310 may include a memory, a computing unit, a database, an industrial software and an industrial network, etc.

The physical system 320 refers to a system which exists in the real world and has physical attributes and dynamic behaviors. The physical system 320 may include a gear shifter, an engine governor, a robot, a machine tool and an automated guided vehicle, etc.

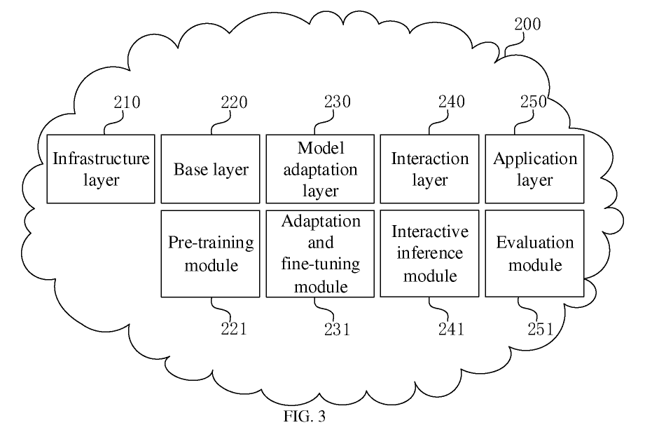

Embodiments of the present application are introduced below in combination with drawings of specification. FIG. 2 is a first structural schematic diagram of an industrial foundation model platform provided by an embodiment of the present application. The industrial foundation model platform provided by the embodiment of the present application is configured to train an industrial foundation model. As shown in FIG. 2, the industrial foundation model platform 200 includes: an infrastructure layer 210, a base layer 220, a model adaptation layer 230, an interaction layer 240, and an application layer 250.

The infrastructure layer 210 is configured to construct basic resources for training the industrial foundation model.

Specifically, the infrastructure layer 210 is a key level in training an industrial foundation model. In industrial scenarios, especially in scenarios that require processing massive amounts of data and executing complex computing tasks, such as aerospace, shipbuilding, automotive, chemical engineering, metallurgical, iron and steel, and many other fields, it has extremely high requirements for storage resources, computing resources, and data processing capabilities to construct an industrial foundation model. The infrastructure layer 210 is designed and deployed to meet these requirements. The infrastructure layer 210 ensures a smooth progress of the training process and provides a solid foundation for final application of the industrial foundation model.

The base layer 220 is configured to perform industrial multimodal pre-training on a preset industrial base model through a preset multimodal dataset to improve processing capability of the industrial foundation model for multimodal data, where the industrial base model is a foundation of the industrial foundation model, and the industrial base model possesses general problem-solving capability for industrial tasks.

Specifically, the base layer 220 is a core support for training an industrial foundation model. The pre-training of the industrial base model involves using a large-scale and downstream-task-independent multimodal dataset, to perform initial training of the industrial foundation model, i.e., industrial multimodal pre-training. Thus, the industrial foundation model is enabled to possess and improve general processing capability for understanding and processing multimodal data in industrial scenarios. Herein, the multimodal dataset can be preset when the industrial foundation model platform is constructed, or can be preset by users when the industrial foundation model is trained according to the industrial foundation model platform.

The base layer 220 can be preset with at least one large model. The industrial base model can be selected independently by users from these large models, or can be selected by users from these large models through certain selection algorithm. The industrial base model possesses general problem-solving capability for industrial tasks, which provides a basis for more refined model adaptation and scenario application of the industrial foundation model.

Further, the base layer 220 is configured to perform the industrial multimodal pre-training on a preset industrial base model or a user-constructed large model through the preset multimodal dataset and/or a user-constructed dataset, so as to improve processing capability of the industrial foundation model for multimodal data.

Specifically, the base layer 220 can perform the industrial multimodal pre-training through the above multimodal dataset, or a dataset constructed independently by users, i.e., the user-constructed dataset, or a dataset including all data of both the multimodal dataset and the user-constructed dataset. It should be noted that when the industrial multimodal pre-training is performed through the user-constructed dataset, improvement degree of the processing capability of the industrial foundation model for multimodal data is affected by data value of the user-constructed dataset.

A training object of the industrial multimodal pre-training may be the above industrial base model, or a user-constructed large model. Herein, the user-constructed large model may be a large model constructed independently by users, or may be a large model constructed by users based on the industrial base model. It should be noted that when the user-constructed large model is used as the training object, improvement degree of the processing capability of the pre-trained user-constructed large model for multimodal data is affected by modeling degree of the user-constructed large model.

The model adaptation layer 230 is configured to perform industrial mechanism embedded fine-tuning on the pre-trained industrial base model through a preset specific dataset to obtain the industrial foundation model, where the specific dataset includes a task-oriented foundation model and a domain foundation model, where the task-oriented foundation model is configured to perform multi-task instruction fine-tuning on the pre-trained industrial base model to improve processing capability of the industrial foundation model for a specific task, where the domain foundation model is configured to perform domain-specific knowledge embedding and adapter fine-tuning on the multi-task instruction fine-tuned industrial base model to improve generalization capability of the industrial foundation model in an unknown domain scenario.

Specifically, after the pre-training is completed, the industrial foundation model can obtain a certain degree of universality and generalization capability to cope with industrial tasks. However, in industrial multi-scenario tasks, the industrial foundation model usually lacks professional knowledge and mechanisms in the industrial domain, resulting in being difficult to accurately understand and process industrial problems, and relatively low credibility of output results. Therefore, multi-task instruction fine-tuning is required.

The model adaptation layer 230 is a core part for training the industrial foundation model. A secondary training of the industrial base model, i.e., industrial mechanism embedded fine-tuning, involves using small-scale specific datasets to perform industrial task adaptation and domain-specific adaptation on the pre-trained industrial base model, so that the industrial foundation model possesses and improves processing capability for specific tasks and generalization capability in an unknown domain scenario.

The industrial task adaptation refers to performing the multi-task instruction fine-tuning through the task-oriented foundation model based on the pre-trained industrial base model; while retaining the general problem-solving capability of the industrial foundation model for industrial tasks, the model is enabled to possess and improve processing capability for specific tasks.

The domain-specific adaptation refers to perform the domain-specific knowledge embedding and the adapter fine-tuning through the domain foundation model based on the multi-task instruction fine-tuned industrial base model, so that the industrial foundation model possesses and improves generalization capability in an unknown domain scenario. Herein, the involved domains include discrete manufacturing fields such as aerospace, shipbuilding, and automotive, as well as process manufacturing fields such as chemical engineering, metallurgical, and iron and steel.

The instruction fine-tuning method commonly used by the industrial foundation model is to fine-tune the pre-trained industrial base model on a paired set of human instructions and desired outputs. In order to fuse industrial knowledge into the industrial foundation model, the industrial foundation model of the embodiments of the present application, compared with the existing industrial foundation models, further needs an industrial knowledge integration and industrial mechanism embedding method. That is, firstly, relevant industrial knowledge needs to be collected from various sources, including empirical knowledge such as process flows and technical specifications. Secondly, the industrial knowledge is converted into forms that the industrial foundation model can understand and process, for example, creating triple data (including a head entity, a relation, and a tail entity) in a knowledge graph, and using knowledge graph embedding technology to convert knowledge into embedding vector features for training. Finally, the industrial foundation model is made to fuse industrial knowledge, which can be achieved by incorporating the knowledge graph into a training objective and performing knowledge graph-based instruction fine-tuning.

In order to embed industrial mechanism equations into the industrial foundation model, the industrial mechanism can be represented as feature information recognizable by a neural network and embedded into a network architecture. Secondly, at the output stage of the model, the model is guided to output a result that conforms to industrial physical laws, for example, by adding mechanism equations in a loss function to penalize an output result that violates physical laws. In addition, the output of the model can be checked and constrained to conform to the industrial mechanisms according to rules in a mechanism knowledge base, or a simulation tool or a manual method can be used to verify credibility and accuracy of the output of the model.

In order to make the industrial foundation model have a stronger adaptability when applied to various industries, a further domain knowledge embedding fine-tuning is needed, so that the industrial foundation model can be more proficient in the professional knowledge of a certain industry, thereby performing excellently in various industries. In the fine-tuning process of the domain foundation model, the adapter fine-tuning can be used to retain task-oriented foundation model fine-tuning while enhancing the industrial foundation model’s adaptability to different industries. Next, detailed industry datasets need to be prepared, and model performance is fine-tuned on these industry-specific datasets to improve the industrial foundation model’s performance on industry professional problems.

Further, the model adaptation layer 230 is configured to perform the industrial mechanism embedded fine-tuning on the pre-trained industrial base model or the user-constructed large model through a preset specific dataset and/or a user-constructed dataset to obtain the industrial foundation model.

The implementation principle and technical effects of the industrial mechanism embedded fine-tuning provided in this embodiment are similar to those of the industrial multimodal pre-training in the above embodiment, which will not be repeated in this embodiment here.

The interaction layer 240 is configured to improve interaction capability of the industrial foundation model through industrial efficient inference, where the industrial foundation model is configured to respectively interact with technical personnel and a cyber-physical system.

Specifically, in the interaction layer 240, the technical personnel, the industrial foundation model and the cyber-physical system are three major interactive objects that perform an interactive collaboration.

The industrial efficient inference enables the industrial foundation model to quickly and accurately process data and make decisions in complex industrial environments. The industrial efficient inference can be implemented based on methods such as model compression, hardware acceleration, and industrial retrieval-augmented generation.

Further, the interaction layer 240 trains the industrial foundation model into an agent, where the technical personnel, the agent, and the cyber-physical system perform an interactive collaboration. Herein, the agent integrates several basic capabilities of the industrial foundation model and enhances memory, planning, action, and perception to interact with outside. Compared with the industrial foundation model, the agent further has proactive perception and control capabilities of the industrial environment, and can spontaneously memorize, observe, and influence the external environment.

The application layer 250 is configured to manifest functions of the industrial foundation model.

Specifically, the application layer 250 is the manifestation form of the industrial foundation model on a server side. The functions of the industrial foundation model enable the industrial foundation model to not only answer a complex query, but also understand and analyze complex industrial environment, make a scientific process decision, directly control the cyber-physical system, and automatically generate a technical document and a simulation design.

The industrial foundation model platform of the embodiment of the present application includes an infrastructure layer, a base layer, a model adaptation layer, an interaction layer, and an application layer. The infrastructure layer is configured to construct basic resources for training the industrial foundation model. The base layer is configured to perform industrial multimodal pre-training to improve processing capability of the industrial foundation model for multimodal data. The model adaptation layer is configured to perform industrial mechanism embedded fine-tuning to improve processing capability of the industrial foundation model for a specific task and generalization capability in an unknown domain scenario. The interaction layer is configured to improve interaction capability of the industrial foundation model. The application layer is configured to manifest functions of the industrial foundation model. The following technical effects are achieved: the model adaptation layer improves the generalization capability of the industrial foundation model in an unknown domain scenario through the domain foundation model, solving the problem of poor generalization capability of the existing industrial foundation models. The model adaptation layer improves the processing capability of the industrial foundation model for the specific task through the industrial base model, solving the problem of lack of understanding of the industrial mechanism in the existing industrial foundation models. The interaction layer improves the interaction capability of the industrial foundation model through the industrial efficient inference, solving the problem of low training efficiency of the existing industrial foundation model.

In a possible design, the task-oriented foundation model includes: an intelligent question-and-answering model, a scene cognition model, a process decision-making model, a terminal control model, a content generation model and a scientific discovery model.

Accordingly, the functions of the industrial foundation model include: intelligent question-and-answering, scene cognition, process decision-making, terminal control, content generation and scientific discovery.

Specifically, the intelligent question-and-answering function means that the industrial foundation model can understand and answer complex questions related to industry and provide an instant information support. The industrial foundation model has extremely strong text understanding and generation capabilities. Combined with specific knowledge in industrial domain and technologies in related domains, it can provide a question-and-answering service anytime and anywhere for full-process tasks.

The scene cognition function means that the industrial foundation model can identify and understand various scenarios and states in industrial environments, providing a basis for further analysis and decision-making. The industrial foundation model has a strong perception capability for information such as vision and sensing, and incorporates it into the decision-making process to optimize the effectiveness of analysis and decision-making.

The process decision-making function means that the industrial foundation model can perform optimal decision-making in complex industrial processes, improving production efficiency and quality. Based on its powerful logical reasoning and calculation capabilities, the industrial foundation model can provide reasonable solutions for various optimization problems abstracted from industrial processes.

The terminal control function means that the industrial foundation model can directly control industrial equipment to achieve an automated operation. Embodied intelligence is one of the important capabilities of the industrial foundation model. Based on the obtained decision-making results and the formed processing schemes, the industrial foundation model can directly control manufacturing equipment to complete industrial tasks.

The content generation function means that the industrial foundation model can create technical documents, design schemes, reports, and other content to improve work efficiency. Based on its huge network architecture and trained on massive data, the industrial foundation model has extremely strong content generation capabilities, and is widely used in applications such as a code generation, an image generation, and a time series data generation.

The scientific discovery function means that the industrial foundation model possesses advanced association capabilities, thereby promoting the development and application of new materials, new processes, new products, and new models. For example, through a large-scale interdisciplinary knowledge integration, the industrial foundation model can identify coupling mechanisms of complex products in multiple fields such as mechanical, electrical, hydraulic, thermal, pneumatic and magnetic, clarify physical and chemical principles in new product design, and provide support for innovative industrial design schemes.

The technical effect of the solution in this embodiment is to enable the industrial foundation model to possess functions of intelligent question-and-answering, scene cognition, process decision-making, terminal control, content generation and scientific discovery through the task-oriented foundation model.

In a possible design, the functions of the industrial foundation model are configured to support applications in research and development design, manufacturing, test and validation, management, and operation and maintenance service.

Specifically, the functions of the industrial foundation model are oriented toward an industrial manufacturing lifecycle, and are configured to support applications in the five industrial links of research and development design, manufacturing, test and validation, management, and operation and maintenance service.

The research and development design involves concept formation, principal design, prototype fabrication, and simulation design of new products to determine final product specifications and performance, ensuring that products can meet market requirements and technical standards. In the research and development design stage, the industrial foundation model mainly provides process assistance in design guidance, scheme generation, and assisted design. Accordingly, the functions that can be realized in research and development design include an intelligent question-and-answering assistant and an industrial content generation.

For the intelligent question-and-answering assistant, the industrial foundation model has a comprehensive and professional industrial knowledge base, and can serve as an industrial knowledge question-and-answering assistant, providing corresponding suggestions for various product design processes, parameter types, and design criteria, and performing rationality demonstration and inspection on design solutions by combining industrial knowledge and mechanism cognition, thereby simplifying the design process.

For the industrial content generation, on the basis of formed design solutions, the industrial foundation model uses its own content generation capability to generate corresponding engineering files from reasonable design results, such as Computer Aided Design (CAD) files or Computer Aided Engineering (CAE) files, forming seamless connection with other industrial software to prepare for subsequent production stages. Meanwhile, based on its own learning of industrial domain knowledge and mechanisms, the industrial foundation model can spontaneously and innovatively explore and generate new structures, new fusion schemes, and new concepts, providing innovative ideas for designers. Additionally, the industrial foundation model can design corresponding simulation systems to perform simulation analysis on design schemes, verify the rationality of parameters and structural designs, and the resulting simulation analysis results can then iteratively optimize the design schemes.

The manufacturing is a process of converting research-and-development-designed products into actual physical items, including raw material procurement, production planning and scheduling, production line optimization, processing and assembly, and quality inspection. In the manufacturing stage, the industrial foundation model mainly provides process assistance in product process generation, manufacturing equipment control, production plan arrangement, and production defect identification. Accordingly, the functions that can be realized in the manufacturing include an operation guidance and manufacturing process control.

For the operation guidance, the industrial foundation model possesses professional knowledge of processing technology, and can guide design workflows and interact with personnel to realize operation process guidance, personnel training, and status feedback interaction. Meanwhile, the industrial foundation model monitors the production process, enabling the personnel to inquire about production status from the industrial foundation model in real time and control the production rhythm.

For the manufacturing process control, the terminal control is a key application of the industrial foundation model in the manufacturing stage. The terminal control mainly includes two parts: manufacturing equipment motion control and manufacturing process control. Based on perception and decision-making capabilities, the industrial foundation model forms intelligent control schemes for equipment, such as motion speed, acceleration, and direction of robotic arms, enhancing the performance, efficiency, and flexibility of motion systems to better complete specific manufacturing tasks.

The test and validation is detection and evaluation on manufactured products in terms of performance, reliability, and safety, to ensure that products meet design requirements and industry standards and can satisfy user’s usage demands. In the test and validation stage, the industrial foundation model mainly provides process assistance in test scheme design, test equipment control, test result analysis, and test report generation. Accordingly, the functions that can be realized in the test and validation include test environment cognition and test report generation.

For the test environment cognition, the test and validation involves various changing test environments. In this process, the industrial foundation model perceives environmental changes through various sensing data, further responds to the environment, and analyzes corresponding test results. Meanwhile, the industrial foundation model also performs real-time monitoring of the tested product, perceives changes in product performance, and identifies product status features.

For the test report generation, the industrial foundation model receives detailed test requirements and design parameters, can generate specific test schemes, and further generate test files that can be executed by equipment, and after testing is completed, generate corresponding test analysis reports to assist research and development personnel in performing product optimization design.

The management is a process by which manufacturing enterprises plan, organize, coordinate, control, and optimize various aspects such as production, sales, finance, and human resources to achieve their business objectives. In the management stage, the industrial foundation model mainly provides process assistance in resource scheduling, production planning and scheduling, document generation, and report analysis. Accordingly, the functions that can be realized in the management include operational status question-and-answering and operational report generation.

For the operational status question-and-answering, the industrial foundation model is integrated into the full production process, enabling management personnel to understand production status at any time through the industrial foundation model, and from raw material supply to production line processing, and then to product sales, they can interact with the industrial foundation model in the form of question-and-answering, while it also includes assisting personnel in retrieving various industrial documents, greatly facilitating management personnel’s control over the full process.

For the operational report generation, the industrial foundation model combines perception and decision-making capabilities to generate specific scheduling schemes, which can be produced according to industrial document or in cooperation with the requirements of other industrial software. Additionally, management personnel can utilize the industrial foundation model to generate production management report, and the industrial foundation model can generate report content containing rich information according to specific requirements of managers, improving management efficiency.

The operation and maintenance service is a technical support and after-sale service provided by manufacturing enterprises to users after product sales, including installation, commissioning, repair, maintenance, and upgrades, to ensure that products can operate normally and stably. Meanwhile, it also includes continuous monitoring of internal manufacturing equipment and product quality of enterprises. In the operation and maintenance service stage, the industrial foundation model mainly provides process assistance in fault diagnosis, after-sale service, and intelligent customer service. Accordingly, the functions that can be realized in the operation and maintenance service include intelligent after-sale service and intelligent fault-tolerant maintenance.

For the intelligent after-sale service, the industrial foundation model monitors the operating status of equipment and products, provides fault early warning and maintenance question-and-answering, and can act as an intelligent after-sale customer service to interact with customers, sorting out various email summaries, reducing labor costs.

For the intelligent fault-tolerant maintenance, when the equipment fails or performance degrades, the industrial foundation model can perform corresponding operational fault-tolerant control to ensure that equipment can still maintain its specified functions or continue operating at the cost of sacrificing performance when faults occur. Based on intelligent detection and diagnosis of perception and decision-making, corresponding control measures are taken to deal with system faults, ensuring safety and reliability of equipment operation, such as adjusting equipment operating parameters, slowing down production rhythm, switching to backup systems, and timely fault early warnings, which gains time for maintenance and reduces accident rates.

The technical effect of the solution in this embodiment is to specifically apply the functions of the industrial foundation model.

In a possible design, the model adaptation layer 230 is further configured to perform scene-knowledge-internalization-enhanced self-training on the domain-specific knowledge embedded and adapter fine-tuned industrial base model through preset limited labeled data, to improve processing capability of the industrial foundation model in industrial subdivision scenarios.

Specifically, the scene-knowledge-internalization-enhanced self-training aims to address the problem of limited labeled data in some subdivision scenarios within industrial domain knowledge. By performing preliminary training on small-scale labeled data, the model is utilized to generate pseudo-labels to annotate large-scale unlabeled data, and reinforcement learning is introduced to set a reward mechanism to optimize the quality of pseudo-labels, thereby improving model performance. In the case of the limited labeled data, the scene-knowledge-internalization-enhanced self-training can support fine-tuning of scenario large model for solving industrial subdivision scenario problems, to improve the processing capability of the industrial foundation model in industrial subdivision scenarios.

The technical effect of the solution in this embodiment is to improve the processing capability of the industrial foundation model in industrial subdivision scenarios through the scene-knowledge-internalization-enhanced self-training.

In a possible design, the base layer 220 is preset with respective toolchains for industrial multimodal pre-training, industrial mechanism embedded fine-tuning, and industrial efficient inference, and a plurality of industrial template foundation models, where the industrial base model is one of the plurality of industrial template foundation models.

Specifically, the base layer 220 is preset with a toolchain for industrial multimodal pre-training, so that it can be called at any time when the base layer 220 performs pre-training on the preset industrial base model. The base layer 220 is also preset with a toolchain for industrial mechanism embedded fine-tuning, so that it can be called at any time when the model adaptation layer 230 performs secondary training on the pre-trained industrial base model. The base layer 220 is also preset with a toolchain for industrial efficient inference, so that it can be called at any time when the interaction layer 240 improves the interaction capability of the industrial foundation model. In addition, the base layer 220 is also preset with a plurality of industrial template foundation models, and technical personnel can select one industrial template foundation model from these industrial template foundation models as the industrial base model according to requirements.

The technical effect of the solution in this embodiment is to solve the problem of support for the industrial foundation model platform by presetting a plurality of toolchains and a plurality of industrial template foundation models in the base layer.

In a possible design, the basic resources include: industrial data, computing resources and industrial knowledge.

The industrial data is used for providing training data for the industrial foundation model.

The computing resources are used for providing computing power support for the industrial foundation model.

The industrial knowledge is used for providing deep-level logic for the industrial foundation model.

Specifically, the industrial data includes sensor signals (such as temperature, pressure, and flow rate) detected by sensing devices, Computer-Aided X (CAX) files, industrial time series data, machine instructions, industrial documents, and multimodal data (such as images, videos, and audios), etc. The industrial data is the foundation for model training and operation. The computing resources include cloud-edge-end computing power and storage for the training and inference of the industrial foundation model, as well as chips specially designed for Artificial Intelligence (AI) computing. The industrial knowledge includes industrial general knowledge and enterprise private knowledge, covering structured documents such as industry specifications, operation documents, machine operation principles, and maintenance experience, as well as dedicated knowledge graphs, providing deep-level logic for decision-making and analysis of the industrial foundation model.

The technical effect of the solution in this embodiment is to solve the problem of basic resources for industrial foundation models by presetting industrial data, computing resources, and industrial knowledge in the infrastructure layer.

FIG. 3 is a second structural schematic diagram of an industrial foundation model platform provided by this embodiment of the present application. As shown in FIG. 3, the industrial foundation model platform provided in this embodiment is further refined based on the industrial foundation model platform provided in the previous embodiments of the present application. Accordingly, the industrial foundation model platform 200 provided in this embodiment further includes: a pre-training module 221 supported by the base layer 220.

The pre-training module 221 is configured to perform industrial multimodal pre-training on the industrial base model through at least one of multiple pre-training methods, where the multiple pre-training methods include: a distributed training method, a transfer learning training method, a self-supervised learning method, and a multi-task training method.

Specifically, in the pre-training module 221, diversified pre-training methods are supported for training the encoder and generator for each modality, including the distributed training method, the transfer learning training method, the self-supervised learning method, and the multi-task training method, etc., which can be arbitrarily combined with each other to meet the training requirements of different technical personnel and scenarios, thereby ensuring that technical personnel can select appropriate pre-training methods according to their own needs.

The pre-training module is further configured to set industrial data called by the industrial base model and a model parameter of the industrial base model.

Specifically, the execution steps of the pre-training module 221 include data pre-processing, model construction, model training, etc.

For the data pre-processing, the pre-training module 221 supports a unified management of the industrial data in the infrastructure layer 210, and the technical personnel can view basic information of the industrial data, including a version number ID, a data volume, and an import log, etc. The technical personnel can customize the industrial data, set data names, select data types, and set data storage locations. When customizing data, the technical personnel can combine the industrial data with functions such as data annotation, data cleaning, and data augmentation to construct industrial data suitable for generative large model scenarios. Herein, the data cleaning includes operations such as converting traditional Chinese to simplified Chinese, converting uppercase to lowercase, and deleting abnormal characters for the text of industrial data. For domain-related corpora of the technical personnel, distribution statistics and quality inspection of text data can be performed. This function can output the overall distribution and quality assessment results of domain corpora, including distribution statistics of data domain types and task types, as well as preliminary data quality inspection. In addition, to help technical personnel quickly get started and verify training effects, the pre-training module 221 can be preset with some industrial-specific industrial data, and technical personnel can directly use these preset industrial data for training and testing, accelerating the model development process.

In the process of model construction and training, the technical personnel can also set model parameters of the industrial foundation model. The pre-training module 221 supports a plurality of optimization algorithms and parallel computing architectures to ensure efficiency and accuracy in large-scale data processing. In addition, the technical personnel can monitor the training progress in real time through visualization tools, analyze performance of the model, and perform necessary tuning operations. After the industrial foundation model training is completed, the pre-training module 221 provides a one-click deployment function, which enables the technical personnel to quickly apply the trained industrial foundation model to production environments to realize intelligent decision-making, process optimization, or other specific business requirements. Meanwhile, the pre-training module 221 also supports online update and iterative optimization of the industrial foundation model, ensuring that it always maintains high efficiency and accuracy in constantly changing industrial scenarios.

The technical effect of the solution in this embodiment is to perform pre-training on the industrial base model through a pre-training module supported by the base layer and adopting diversified training methods.

In a possible design, the industrial foundation model platform 200 further includes: an adaptation and fine-tuning module 231 supported by the model adaptation layer 230.

The adaptation and fine-tuning module 231 is configured to perform industrial mechanism embedded fine-tuning on the pre-trained industrial base model through one of multiple fine-tuning training methods, where the multiple fine-tuning training methods include: an industrial knowledge integration and industrial mechanism embedding method, a supervised fine-tuning method, a direct preference optimization method, and a reinforcement learning from human feedback method.

Specifically, after the pre-training module 221 completes the pre-training on the industrial base model, the adaptation and fine-tuning module 231 performs fine-tuning on the model to enhance its performance and its ability to follow human commands. In the adaptation and fine-tuning module 231, diversified fine-tuning training methods are supported, including the industrial knowledge integration and industrial mechanism embedding method, the supervised fine-tuning method, the direct preference optimization method, and the reinforcement learning from human feedback method, etc., enabling the technical personnel to select an appropriate fine-tuning training method according to their own requirements.

The industrial knowledge integration and industrial mechanism embedding method integrates industrial knowledge into the industrial foundation model by creating triple data in knowledge graphs and using knowledge graph embedding technology to convert knowledge into embedding vector features for training. Secondly, in order to embed industrial mechanism-based models into the industrial foundation model, the industrial mechanism can be represented as feature information recognizable by a neural network and embedded into a network architecture. At the output stage of the model, the model is guided to output a result that conforms to industrial physical laws, for example, by adding mechanism equations in a loss function to penalize an output result that violates physical laws.

The supervised fine-tuning uses a pre-trained neural network model and retrains it on a small amount of supervised data to adapt to specific task requirements. The process of performing additional training on the basis of the pre-trained industrial base model is usually to make the industrial foundation model better adapt to specific domains or tasks.

The direct preference optimization method precisely controls the output of the industrial foundation model by directly optimizing the output of the language model without performing reinforcement learning. This method can accurately understand and learn the preferences of the technical personnel, achieving more outstanding effects.

The reinforcement learning from human feedback refers to incorporating human feedback into the training process, enabling the industrial foundation model to quickly master human experience, using human preferences as reward signals to guide model’s training, thereby enhancing the model’s understanding of human intentions and fulfillment thereof. The success of the reinforcement learning from human feedback depends on quality of the feedback provided by humans. The adaptation and fine-tuning module 231 has developed effective and scalable methods to collect and process such feedback. The adaptation and fine-tuning module 231 connects multi-round dialogue and ranking-type, prompt corpora datasets as human feedback for Reinforcement Learning from Human Feedback (RLHF) training, further enhancing the intelligence and effectiveness of the industrial foundation model.

The technical effect of the solution in this embodiment is to achieve fast training of the industrial foundation model through the adaptation and fine-tuning module supported by the model adaptation layer and adopting efficient model training means.

In a possible design, the industrial foundation model platform 200 further includes: an interactive inference module 241 supported by the interaction layer 240.

The interactive inference module 241 is configured to improve interaction capability of the industrial foundation model through a plurality of interactive inference optimization methods, where the plurality of interactive inference optimization methods include: inference acceleration, industrial knowledge base retrieval-augmented generation, model orchestration, and plugin mechanism.

Specifically, in the interactive inference module 241, the fine-tuned industrial foundation model can infer conclusions expected by the technical personnel or predict future events based on input information and the existing knowledge. The interactive inference module 241 enhances the capabilities of the industrial foundation model in specific industrial domains and optimizes the performance of knowledge-intensive tasks through a plurality of interactive inference optimization methods such as the inference acceleration, the industrial knowledge base retrieval-augmented generation (RAG), the model orchestration, and the plugin mechanism.

In terms of inference acceleration, a plurality of technologies such as model compression, pruning, and quantization can be adopted to reduce the computational and storage requirements of the industrial foundation model, thereby improving inference speed. Meanwhile, high-performance hardware such as a Graphic Processing Unit (GPU) and a Tensor Processing Unit (TPU) is supported to accelerate the inference process. These hardware acceleration technologies enable the industrial foundation model to efficiently process massive data, meeting industrial application scenarios with high real-time requirements, such as production line real-time monitoring and equipment fault detection. The inference acceleration can also reduce energy consumption and operational costs, making the industrial foundation model more applicable and accessible in industrial sites with limited resources.

In terms of the RAG, the interactive inference module 241 combines retrieval and generation technologies, which is particularly applicable to knowledge-intensive tasks in industrial scenarios. The RAG first builds an industrial knowledge base covering product design, process flows, equipment maintenance, and other content. Then, efficient retrieval algorithms such as best match and dense retrieval are used to find relevant information from the knowledge base. Based on the retrieved results, the industrial foundation model further generates more accurate and targeted answers. In the industrial manufacturing field, the RAG can be used to quickly provide technical support, generate maintenance manuals, and optimize production processes. For example, in equipment maintenance, the technical personnel can quickly find fault solutions through the RAG and automatically generate detailed maintenance steps, improving maintenance efficiency and accuracy.

The model orchestration involves model selection, task allocation, and result integration to achieve complex industrial tasks. The model selection selects suitable large models or small models according to specific task requirements. The task allocation decomposes complex tasks into subtasks and assigns them to the most suitable models. The result integration aggregates the outputs of sub-models through methods such as weighted averaging or logistic regression to generate final solutions. For example, in an intelligent factory, a large model is responsible for production planning and scheduling, while a small model handles operation monitoring and quality inspection. Through the model orchestration, the overall production process is optimized and system efficiency is improved.

In terms of the plugin mechanism, the interactive inference module 241 supports an installation and use of customized plugins to extend the functions of the industrial foundation model. These plugins can be used to add new inference algorithms, support more data types or formats, and provide visualization interfaces, etc. The interactive inference module 241 also provides a rich plugin resource library, such as knowledge base plugins and web parsing plugins, and technical personnel can search for, select, and install corresponding plugins as needed. In addition, the technical personnel can integrate internal services into service orchestration through customized plugins. The plugin mechanism enhances scalability and customization capabilities of the interactive inference module 241, enabling it to demonstrate flexibility and adaptability in more application scenarios and meet the requirements of a wide range of technical personnel.

The technical effect of the solution in this embodiment is to improve processing speed and resource efficiency of the industrial foundation model, expand application scenarios, and enhance adaptability and problem-solving capability of the industrial foundation model for complex industrial tasks through the interactive inference module supported by the interaction layer.

In a possible design, the industrial foundation model platform 200 further includes: an evaluation module 251 supported by the application layer 250.

The evaluation module is configured to evaluate functions of the industrial foundation model through at least one of multiple evaluation methods, where the multiple evaluation methods include an automatic evaluation and a manual evaluation.

Specifically, the evaluation module 251 includes a series of evaluation indicators and methods for performing performance evaluation on trained industrial foundation models. The evaluation module 251 provides two evaluation methods: an automatic evaluation and a manual evaluation, aiming to comprehensively measure performance in various aspects such as semantic understanding, knowledge reasoning, professional capability, application capability, instruction following, robustness, bias, hallucination, and safety. In addition, it also performs an evaluation on industrial-specific tasks such as product design, process design, and quality control.

The automatic evaluation refers to an objective evaluation on the output generated by the industrial foundation model through computer algorithms and statistical methods. This method is widely applied to various tasks and can quickly and accurately evaluate model performance. Automatic evaluation usually relies on predefined evaluation indicators and algorithms, mainly quantifying the performance of the industrial foundation model in specific tasks by calculating metrics such as accuracy, recall, and perplexity. For industrial-specific tasks, the automatic evaluation also involves application effectiveness and practicality in actual production environments. These tasks cover all links of the industrial production, from product design to after-sale service, including but not limited to manufacturing application capabilities such as product design, process design, quality control, marketing management, after-sale service, planning and scheduling, production operations, warehousing and logistics, equipment management, safety and environmental protection, energy management, and supply chain. This type of evaluation not only focuses on technical indicators, but also emphasizes the performance and value of the industrial foundation model in practical applications. Through evaluation, the applicability and benefits of the industrial foundation model in industrial environments can be comprehensively understood, thereby providing a basis for the improvement and optimization of the industrial foundation model.

The manual evaluation refers to a subjective evaluation on the output generated by the industrial foundation model by evaluators. To ensure consistency and accuracy of evaluation, a set of evaluation indicators and scoring criteria is usually designed. For example, fluency, accuracy, relevance, and innovativeness of text generated by the model can all serve as evaluation dimensions. Evaluators score the performance of the industrial foundation model according to these standards and provide detailed feedback and improvement suggestions.

The evaluation module 251 comprehensively measures the performance of the industrial foundation model in aspects such as semantic understanding, knowledge reasoning, and industrial applications by combining an automatic evaluation and a manual evaluation. The automatic evaluation provides efficient and objective quantitative analysis, while manual evaluation supplements detailed considerations of the industrial foundation model in practical applications through the subjective feedback from evaluators. The two complement each other, providing comprehensive data support and practical references for the optimization and improvement of the industrial foundation model, ensuring that the industrial foundation model can better adapt to complex industrial application scenarios.

The technical effect of the solution in this embodiment is to perform a performance evaluation on the trained industrial foundation model through the evaluation module supported by the application layer.

The embodiments of the present application also provide an industrial foundation model platform system. The industrial foundation model platform system includes: an industrial foundation model, and a cyber-physical system which interacts with the industrial foundation model.

The industrial foundation model is a model obtained through training by the industrial foundation model platform provided in the above embodiments of the present application.

The implementation principle and technical effects of the industrial foundation model platform system provided in this embodiment are similar to those of the industrial foundation model platform in the above embodiment, which will not be repeated here. The above industrial foundation model platform includes at least one processor and a memory communicatively connected with the at least one processor. The memory is configured to store a program. Specifically, the program may include a program code, where the program code includes a computer-executable instruction. The memory may include a high-speed RAM memory, and may also include a non-volatile memory. The processor is configured to execute the computer-executable instruction stored in the memory. The processor may be a central processing unit (abbreviated as CPU), or an application specific integrated circuit (abbreviated as ASIC), or one or more integrated circuits configured to implement the functions of the industrial foundation model platform of the present application.

So far, the technical solutions of the present application have been described in conjunction with the preferred embodiments shown in the drawings. However, it is easily understood by those skilled in the art that the scope of protection of the present application is by no means limited to these specific embodiments. The above embodiments are intended to illustrate the technical solutions of the present application, but not to intended to limit them; notwithstanding the detailed description of the present application by reference to the foregoing embodiments, it should be understood to those skilled in the art that they can still modify the technical solutions described in the foregoing embodiments or equivalently replace some or all of the technical features thereof; such modifications or replacements do not cause the essence of the corresponding technical solutions to depart from the scope of the technical solutions of the embodiments of the present application.

What is claimed is:

1. An industrial foundation model platform, wherein the industrial foundation model platform is configured to train an industrial foundation model, and the industrial foundation model platform comprises: an infrastructure layer, a base layer, a model adaptation layer, an interaction layer, and an application layer;
wherein the infrastructure layer is configured to construct basic resources for training the industrial foundation model;
the base layer is configured to perform industrial multimodal pre-training on a preset industrial base model through a preset multimodal dataset, wherein the industrial base model is a foundation of the industrial foundation model, and the industrial base model possesses general problem-solving capability for industrial tasks;
the model adaptation layer is configured to perform industrial mechanism embedded fine-tuning on the pre-trained industrial base model through a preset specific dataset to obtain the industrial foundation model, wherein the specific dataset comprises a task-oriented foundation model and a domain foundation model, wherein the task-oriented foundation model is configured to perform multi-task instruction fine-tuning on the pre-trained industrial base model, wherein the domain foundation model is configured to perform domain-specific knowledge embedding and adapter fine-tuning on the multi-task instruction fine-tuned industrial base model;
the interaction layer is configured to perform industrial inference, wherein the industrial foundation model is configured to respectively interact with technical personnel and a cyber-physical system;
the application layer is configured to manifest functions of the industrial foundation model.

2. The industrial foundation model platform according to claim 1, wherein the task-oriented foundation model comprises: an intelligent question-and-answering model, a scene cognition model, a process decision-making model, a terminal control model, a content generation model and a scientific discovery model;
wherein the functions of the industrial foundation model comprise: intelligent question-and-answering, scene cognition, process decision-making, terminal control, content generation and scientific discovery.

3. The industrial foundation model platform according to claim 2, wherein the functions of the industrial foundation model are configured to support applications in research and development design, manufacturing, test and validation, management, and operation and maintenance service.

4. The industrial foundation model platform according to claim 1, wherein the model adaptation layer is further configured to perform scene-knowledge-internalization-enhanced self-training on the domain-specific knowledge embedded and adapter fine-tuned industrial base model through preset limited labeled data.

5. The industrial foundation model platform according to claim 2, wherein the model adaptation layer is further configured to perform scene-knowledge-internalization-enhanced self-training on the domain-specific knowledge embedded and adapter fine-tuned industrial base model through preset limited labeled data.

6. The industrial foundation model platform according to claim 3, wherein the model adaptation layer is further configured to perform scene-knowledge-internalization-enhanced self-training on the domain-specific knowledge embedded and adapter fine-tuned industrial base model through preset limited labeled data.

7. The industrial foundation model platform according to claim 1, wherein the base layer is preset with respective toolchains for industrial multimodal pre-training, industrial mechanism embedded fine-tuning, and industrial inference, and a plurality of industrial template foundation models, wherein the industrial base model is one of the plurality of industrial template foundation models.

8. The industrial foundation model platform according to claim 1, wherein the basic resources comprise: industrial data, computing resources and industrial knowledge;
wherein the industrial data is used for providing training data for the industrial foundation model;
the computing resources are used for providing computing power support for the industrial foundation model;
the industrial knowledge is used for providing deep-level logic for the industrial foundation model.

9. The industrial foundation model platform according to claim 8, wherein the industrial foundation model platform further comprises: a pre-training module supported by the base layer;
wherein the pre-training module is configured to perform the industrial multimodal pre-training on the industrial base model through at least one of multiple pre-training methods, wherein the multiple pre-training methods comprise: a distributed training method, a transfer learning training method, a self-supervised learning method, and a multi-task training method;
wherein the pre-training module is further configured to set industrial data called by the industrial base model and a model parameter of the industrial base model.

10. The industrial foundation model platform according to claim 1, wherein the industrial foundation model platform further comprises: an adaptation and fine-tuning module supported by the model adaptation layer;
wherein the adaptation and fine-tuning module is configured to perform the industrial mechanism embedded fine-tuning on the pre-trained industrial base model through one of multiple fine-tuning training methods, wherein the multiple fine-tuning training methods comprise: an industrial knowledge integration and industrial mechanism embedding method, a supervised fine-tuning method, a direct preference optimization method, and a reinforcement learning from human feedback method.

11. The industrial foundation model platform according to claim 1, wherein the industrial foundation model platform further comprises: an interactive inference module supported by the interaction layer;
wherein the interactive inference module is configured to perform a plurality of interactive inference optimization methods, wherein the plurality of interactive inference optimization methods comprise: inference acceleration, industrial knowledge base retrieval-augmented generation, model orchestration, and plugin mechanism.

12. The industrial foundation model platform according to claim 1, wherein the industrial foundation model platform further comprises: an evaluation module supported by the application layer;
wherein the evaluation module is configured to evaluate functions of the industrial foundation model through at least one of multiple evaluation methods, wherein the multiple evaluation methods comprise: an automatic evaluation and a manual evaluation.

13. An industrial foundation model platform system, wherein the industrial foundation model platform system comprises: an industrial foundation model, and a cyber-physical system which interacts with the industrial foundation model;
wherein the industrial foundation model is a model obtained through training by the industrial foundation model platform according to claim 1.

14. The industrial foundation model platform system according to claim 13, wherein the task-oriented foundation model comprises: an intelligent question-and-answering model, a scene cognition model, a process decision-making model, a terminal control model, a content generation model and a scientific discovery model;
wherein the functions of the industrial foundation model comprise: intelligent question-and-answering, scene cognition, process decision-making, terminal control, content generation and scientific discovery.

15. The industrial foundation model platform system according to claim 14, wherein the functions of the industrial foundation model are configured to support applications in research and development design, manufacturing, test and validation, management, and operation and maintenance service.

16. The industrial foundation model platform system according to claim 13, wherein the model adaptation layer is further configured to perform scene-knowledge-internalization-enhanced self-training on the domain-specific knowledge embedded and adapter fine-tuned industrial base model through preset limited labeled data.

17. The industrial foundation model platform system according to claim 14, wherein the model adaptation layer is further configured to perform scene-knowledge-internalization-enhanced self-training on the domain-specific knowledge embedded and adapter fine-tuned industrial base model through preset limited labeled data.

18. The industrial foundation model platform system according to claim 15, wherein the model adaptation layer is further configured to perform scene-knowledge-internalization-enhanced self-training on the domain-specific knowledge embedded and adapter fine-tuned industrial base model through preset limited labeled data.

19. The industrial foundation model platform system according to claim 13, wherein the base layer is preset with respective toolchains for industrial multimodal pre-training, industrial mechanism embedded fine-tuning, and industrial inference, and a plurality of industrial template foundation models, wherein the industrial base model is one of the plurality of industrial template foundation models.

20. The industrial foundation model platform system according to claim 13, wherein the basic resources comprise: industrial data, computing resources and industrial knowledge;
wherein the industrial data is used for providing training data for the industrial foundation model;
the computing resources are used for providing computing power support for the industrial foundation model;
the industrial knowledge is used for providing deep-level logic for the industrial foundation model.
